(19) United States
(12) Patent Application Publication
(10) Pub. No.: US 2017/0076199 A1
(43) Pub. Date: Mar. 16, 2017

(54) NEURAL NETWORK SYSTEM, AND COMPUTER-IMPLEMENTED METHOD OF GENERATING TRAINING DATA FOR THE NEURAL NETWORK

(71) Applicant: National Institute of Information and Communications Technology, Tokyo (JP)

(72) Inventors: Jingyi ZHANG, Tokyo (JP); Masao UCHIYAMA, Tokyo (JP)

(21) Appl. No.: 14/853,237

(22) Filed: Sep. 14, 2015

(51) Int. Cl. G06N 3/08; G06F 17/28

(52) U.S. Cl. CPC G06N 3/08; G06F 17/2827

(57) ABSTRACT

A neural network 80 for aligning a source word in a source sentence to a word or words in a target sentence parallel to the source sentence, includes: an input layer 90 to receive an input vector 82. The input vector includes an m-word source context 50 of the source word, n−1 target history words 52, and a current target word 98 in the target sentence. The neural network 80 further includes: a hidden layer 92 and an output layer 94 for calculating and outputting a probability as an output 96 of the current target word 98 being a translation of the source word.

### BACKGROUND OF THE INVENTION

Field of the Invention

The present invention is related to translation models in statistical machine translation, and more particularly, it is related to translation models comprised of a neural network capable of learning in a short time, and a method of generating training data for the neural network.

Description of the Background Art

### Introduction

Neural network translation models, which learn mappings over real-valued vector representations in high-dimensional space, have recently achieved large gains in translation accuracy (Hu et al., 2014; Devlin et al., 2014; Sundermeyer et al., 2014; Auli et al., 2013; Schwenk, 2012).

Notably, Devlin et al. (2014) proposed a neural network joint model (NNJM), which augments the n-gram neural network language model (NNLM) with an m-word source context window, as shown in FIG. 1.

Referring to FIG. 1, the neural network 30 proposed by Devlin et al. includes an input layer 42 for receiving an input vector 40, a hidden layer 44 connected to receive outputs of input layer 42 for calculating weighted sums of the outputs of input layer 42 and for outputting the weighted sums transformed by logistic sigmoid functions, and an output layer 46 connected to receive the output of hidden layer 44 for outputting the weighted sums of outputs of hidden layer 44.

Let T=t₁^{|T|} be a translation of S=s₁^{|S|}. The NNJM (Devlin et al., 2014) defines the following probability,

$$P ( T \vert S ) = {\prod }_{i = 1}^{\vert T \vert} P ( {t}_{i} \vert {s}_{{a}_{i} - ( m - 1 ) / 2}^{{a}_{i} + ( m - 1 ) / 2} , {t}_{i - n + 1}^{i - 1} ) \qquad ( 1 )$$

where target word tᵢ is affiliated with source word sₐ_{ᵢ}. Affiliation aᵢ is derived from the word alignments using heuristics.

To estimate these probabilities, the NNJM uses m source context words and n−1 target history words as input to a neural network. Hence, as shown in FIG. 1, input vector 40 includes m-word source contexts 50 and n−1 target history words 52 (tᵢ₋ₙ₊₁ to tᵢ₋₁). The NNJM (neural network 30) then performs estimation of un-normalized probabilities p(tᵢ|C) before normalizing over all words in the target vocabulary V,

$$P ( {t}_{i} \vert C ) = \frac{p ( {t}_{i} \vert C )}{Z ( C )} \\ Z ( C ) = {\sum }_{{i}_{i}^{′} ∈ V} p ( {t}_{i}^{′} \vert C ) \qquad ( 2 )$$

where C stands for source and target context words as in Equation 1. The outputs 48 of output layer 46 shows these probabilities p(tᵢ|C). Here, m-word source contexts 50 means a set of consecutive (m−1)/2 words immediately before the current source word, a set of consecutive (m−1)/2 words immediately after the current source word, and the current source word.

The NNJM can be trained on a word-aligned parallel corpus using standard maximum likelihood estimation (MLE), but the cost of normalizing over the entire vocabulary to calculate the denominator in Equation 2 is quite large. Devlin et al. (2014)'s self-normalization technique can avoid normalization cost during decoding, but not during training.

To remedy the problem of long training times in the context of NNLMs, Vaswani et al. (2013) used a method called noise contrastive estimation (NCE). Compared with MLE, NCE does not require repeated summations over the whole vocabulary and performs nonlinear logistic regression to discriminate between the observed data and artificially generated noise.

NCE also can be used to train NNLM-style models (Vaswani et al., 2013) to reduce training times. NCE creates a noise distribution q (tᵢ), selects k noise samples tᵢₗ, . . . , tᵢₖ for each tᵢ and introduces a random variable v which is 1 for training examples and 0 for noise samples,

$$P ( v = 1 , {t}_{i} \vert C ) = \frac{1}{1 + k} \cdot \frac{p ( {t}_{i} \vert C )}{Z ( C )}$$

$$P ( v = 0 , {t}_{i} \vert C ) = \frac{k}{1 + k} \cdot q ( {t}_{i} )$$

NCE trains the model to distinguish training data from noise by maximize the conditional likelihood,

$$L = log P ( v = 1 \vert C , {t}_{i} ) + {\sum }_{j = 1}^{k} log P ( v = 0 \vert C , {t}_{ik} )$$

The normalization cost can be avoided by using p (tᵢ|C) as an approximation of P (tᵢ|C). The theoretical properties of self-normalization techniques, including NCE and Devlin et al. (2014)'s method, are investigated by Andreas and Klein (2015).

### SUMMARY OF THE INVENTION

While this model is effective, the computation cost of using it in a large-vocabulary SMT task is quite expensive, as probabilities need to be normalized over the entire vocabulary. If the output layer include N neurons (nodes), the computation order will be as large as O(N×number of neurons in the hidden layer). Because N could be as larger than several hundred thousand in the statistical machine translation, the computational cost would be quite huge. To solve this problem, Devlin et al. (2014) presented a technique to train the NNJM to be self-normalized and avoided the expensive normalization cost during decoding. However, they also note that this self-normalization technique sacrifices neural network accuracy, and the training process for the self-normalized neural network is very slow, as with standard MLE.

It would be desirable to provide a neural network system that can be efficiently trained with standard MLE and efficiently.

According to the first aspect of the present invention, a neural network system for aligning a source word in a source sentence to a word or words in a target sentence parallel to the source sentence, includes: an input layer connected to receive an input vector. The input vector includes an m-word source context (m being an integer larger than two) of the source word, n−1 target history words (n being an integer larger than two), and a current target word in the target sentence. The neural network system further includes: a hidden layer connected to receive the outputs of the input layer for transforming the outputs of the input layer using a pre-defined function and outputting the transformed outputs; and an output layer connected to receive outputs of the hidden layer for calculating and outputting an indicator with regard to the current target word being a translation of the source word.

Preferably, the output layer includes a first output node connected to receive outputs of the hidden layer for calculating and outputting a first indicator of the current target word being the translation of the source word.

Further preferably, the first indicator indicates a probability of the current target word being the translation of the source word.

Still more preferably, the output layer further includes a second output node connected to receive outputs of the hidden layer for calculating and outputting a second indicator of the current target word not being the translation of the source word.

The second indicator may indicate a probability of the current target word not being the translation of the source word.

Preferably, the number m is an odd integer larger than two.

More preferably, the m-word source context includes (m−1)/2 words immediately before the source word in the source sentence, and (m−1)/2 words immediately after the source word in the source sentence, and the source word.

A third aspect of the present invention is directed to a computer program embodied on a computer-readable medium for causing a computer to generate training data for training a neural network. The computer includes a processor, storage, and a communication unit capable of communicating with external devices. The computer program includes: a computer code segment for causing the communication unit to connect to a first storing device and a second storing device. The first storing device stores translation probability distribution (TPD) of each of target language words in a corpus, and the second storing device stores a set of parallel sentence pairs of a source language and a target language. The computer program further includes: a computer code segment for causing the processor to select one of the sentence pairs stored in the second strong device; a computer code segment for causing the processor to select each of words in the source language sentence in the selected sentence pairs; a computer code segment for causing the processor to generate a positive example using the selected source word, m-word source context, n−1 target word history, a target word aligned with the selected source word in the sentence pairs, and a positive flag; a computer code segment for causing the processor to select a TPD for the target word aligned with the selected source word; a computer code segment for causing the processor to sample a noise word in the target language in accordance with the selected TPD; and a computer code segment for generating a negative example using the selected source word, m-word source context, n−1 target word history, and a target word sampled in accordance with the selected TPD, and a negative flag; and a computer code segment for causing the processor to store the positive example and the negative example in the storage.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows the structure of neural network 30 of the Related Art.

FIG. 2 shows the schematic structure of neural network of one embodiment of the present invention.

FIG. 3 schematically shows the structure of the input layer of the neural network shown in FIG. 2.

FIG. 4 schematically shows the structure of the hidden layer of the neural network shown in FIG. 2.

FIG. 5 schematically shows the structure of the output layer of the neural network shown in FIG. 2.

FIG. 6 schematically shows an example of alignment between Chinese sentence and an English sentence.

FIG. 7 schematically shows the structure of a training data generating apparatus for generating training data for the neural network shown in FIGS. 2 to 5.

FIG. 8 shows an overall control structure of a computer program for generating training data for the neural network of the present invention.

FIG. 9 shows an overall control structure of a computer program for aligning a bilingual sentence pair.

FIG. 10 shows an appearance of a computer system executing the DNN learning process in accordance with an embodiment.

FIG. 11 is a block diagram showing an internal configuration of the computer shown in FIG. 10.

### DESCRIPTION OF THE PREFERRED EMBODIMENTS

### Binarized NNJM

In the present application, we propose an alternative framework of binarized NNJMs (BNNJM), which are similar to the NNJM, but use the current target word not as the output, but as the input of the neural network, estimating whether the target word under examination is correct or not, as shown in FIG. 2.

Referring to FIG. 2, neural network 80 of the present embodiment includes: an input layer 90 connected to receive an input vector 82, a hidden layer 92 connected to receive outputs of input layer 90 for outputting a weighted values of the outputs of input layer 90, and an output layer 94 connected to receive outputs of hidden layer 92 for outputting two binarized values as an output 96.

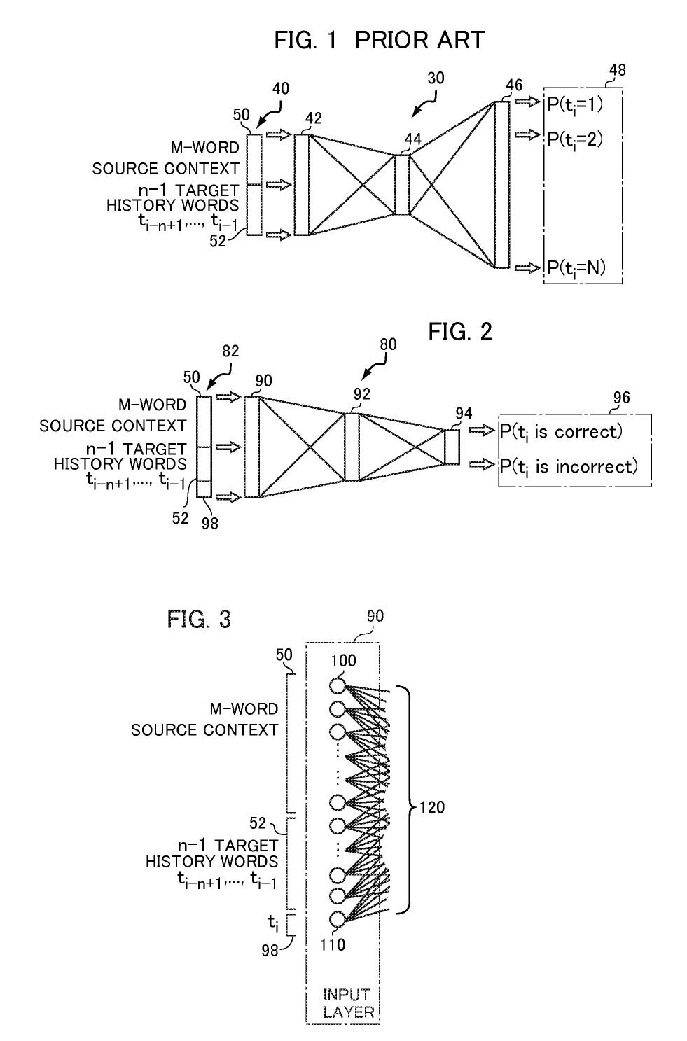

Input vector 82 includes: m-word source contexts 50, n−1 target history words 52 (n is an integer larger than two), as in the case of input vector 40 shown in FIG. 1, but further includes a current target word 98 (tᵢ). The output 96 of output layer 94 includes P(tᵢ is correct) and P(tᵢ is incorrect).

Referring to FIG. 3, input layer 90 include a number of input nodes 100, . . . ,110 connected to receive respective elements of input vector 82 for outputting respective elements to each of the nodes in hidden layer 92 through connections 120.

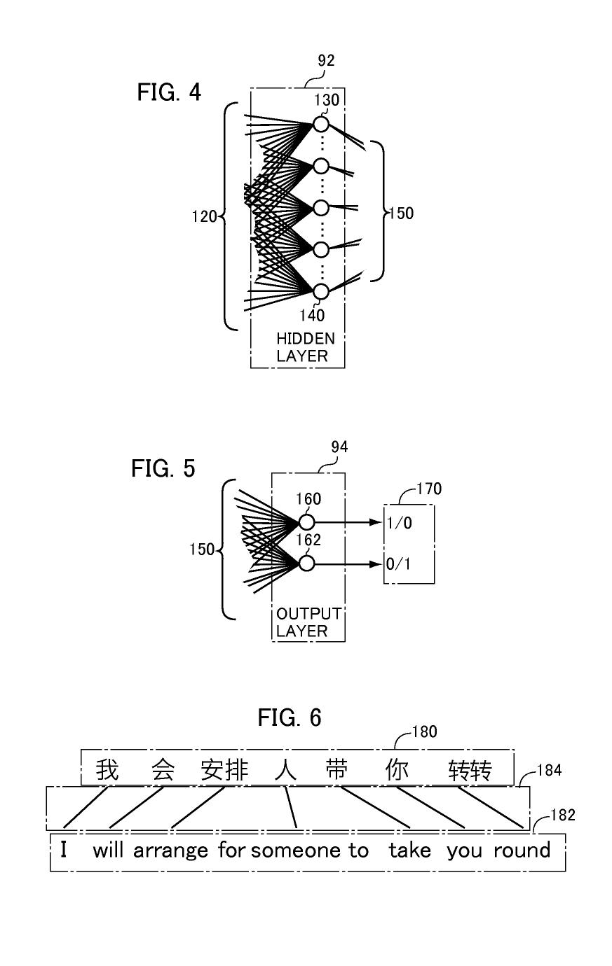

Referring to FIG. 4, hidden layer 92 includes a number of hidden nodes 130, . . . ,140 each connected to receive the outputs of input nodes 100, . . . ,110 through connections 120 for calculating weighted sum of these inputs and for outputting the weighted sums transformed by the logistic sigmoid function onto the connections 150. A weight is assigned to each connection of connections 150 and a bias is assigned to each of the hidden nodes 130, . . . ,140. These weights and biases are a part of the parameters to be trained.

Referring to FIG. 5, output layer 94 includes two nodes 160 and 162 each connected to receive outputs of hidden layer 92 through connections 150 for calculating weighted sums of the inputs and for outputting the sums transformed by a softmax functions. A weight is assigned to each connection in connections 150 and a bias is assigned to each of the nodes 160 and 162 for weighted sums of the inputs. These weights and biases are the rest of the parameters to be trained.

BNNJM learns not to predict the next word given the context, but solves a binary classification problem by adding a variable v ∈ {0, 1} that stands for whether the current target word ti is correctly/wrongly produced in terms of source context words sₐ_{ᵢ}_{-(m-1/2}^{a}^{ᵢ}^{+(m-1)/2} and target history words tᵢ₋ₙ₋₁ⁱ⁻¹,

$$P ( v \vert {s}_{{a}_{i} - ( m - 1 ) / 2}^{{a}_{i} + ( m - 1 ) / 2} , {t}_{i - n + 1}^{i - 1} , {t}_{i} ) .$$

Here, the integer m is an odd number larger than two, and the source context words sₐ_{ᵢ}_{-(m-1)/2}^{a}^{ᵢ}^{⇄(m+1)/2} include (m−1)/2 words immediately before the source word sₐ_{ᵢ}, and (m−1)/2 words immediately after the source word sₐ_{ᵢ}, and the source word sₐ_{ᵢ}.

The BNNJM is learned by a feed-forward neural network with m+n inputs

$$\{ {s}_{{a}_{i} - ( m - 1 ) / 2}^{{a}_{i} + ( m - 1 ) / 2} , {t}_{i - n + 1}^{i - 1} , {t}_{i} \}$$

and two outputs for v=1/0.

Because the BNNJM learns a simple binary classifier, given the context and target words, it can be trained by MLE very efficiently. “Incorrect” target words for the BNNJM can be generated in the same way as NCE generates noise for the NNJM.

The BNNJM uses the current target word as input; therefore, the information about the current target word can be combined with the context word information and processed in the hidden layers. Thus, the hidden layers can be used to learn the difference between correct target words and noise in the BNNJM, while in the NNJM the hidden layers just contain information about context words and only the output layer can be used to discriminate between the training data and noise, giving the BNNJM more power to learn this classification problem.

We can use the BNNJM probability in translation as an approximation for the NNJM as below,

$$P ( {t}_{i} \vert {s}_{{a}_{i} - ( m - 1 ) / 2}^{{a}_{i} + ( m - 1 ) / 2} , {t}_{i - n + 1}^{i - 1} ) \approx P ( v = 1 \vert {s}_{{a}_{i} - ( m - 1 ) / 2}^{{a}_{i} + ( m - 1 ) / 2} , {t}_{i - n + 1}^{i - 1} , {t}_{i} )$$

As a binary classifier, the gradient for a single example in the BNNJM can be trained efficiently by MLE without it being necessary to calculate the softmax over the full vocabulary. On the other hand, we need to create “positive” and “negative” examples for the classifier. Positive examples can be extracted directly from the word-aligned parallel corpus as,

$$〈 {s}_{{a}_{i} - ( m - 1 ) / 2}^{{a}_{i} + ( m - 1 ) / 2} , {t}_{i - n + 1}^{i - 1} , {t}_{i} 〉$$

and a positive flag v (v=1). Here, flag v indicates whether the example is positive or not.

Negative examples can be generated for each positive example in the same way that NCE generates noise data as,

$$〈 {s}_{{a}_{i} - ( m - 1 ) / 2}^{{a}_{i} + ( m - 1 ) / 2} , {t}_{i - n + 1}^{i - 1} , {t}_{i}^{′} 〉$$

and a negative flag v (v=0), where t′ᵢ ∈ V\{tᵢ}.

### Noise Sampling

As we cannot use all words in the vocabulary as noise for computational reasons, we must sample negative examples from some distribution. In the present embodiment, we examine noise from two distributions.

### Unigram Noise

Vaswani et al. (2013) adopted the unigram probability distribution (UPD) to sample noise for training NNLMs with NCE,

$$q ( {t}_{i}^{′} ) = \frac{occur ( {t}_{i}^{′} )}{{\sum }_{{t}_{i}^{″} ∈ V}^{ } occur ( {t}_{i}^{″} )}$$

where occur (t′₁) stands for how many times tl occurs in the training corpus.

### Translation Model Noise

In the present embodiment, we propose a noise distribution specialized for translation models, such as the NNJM or BNNJM.

FIG. 6 gives a Chinese-to-English parallel sentence pair with word alignments to demonstrate the intuition behind our method. The pair includes a Chinese sentence 180 and an English sentence 182. The words in these sentences are aligned by an alignment 184.

Focusing on sₐ_{ᵢ}=“ [symbol] ”, this is translated into tᵢ=“arrange”. For this positive example, UPD is allowed to sample any arbitrary noise as in Example 1.

### EXAMPLE 1

### I will banana

### EXAMPLE 2

### I will arranges

### EXAMPLE 3

### I will arrangement

However, Example 1 is not a useful training example, as constraints on possible translations given by the phrase table ensure that [symbol] will never be translated into “banana”. On the other hand, “arranges” and “arrangement” in Examples 2 and 3 are both possible translations of “ [symbol] ” and are useful negative examples for the BNNJM, that we would like our model to penalize.

Based on this intuition, we propose the use of another noise distribution that only uses tᵢ′ that are possible translations of sₐ_{ᵢ}, i.e., t′ᵢ∈ U(sₐ_{ᵢ})\{tᵢ}, where U(sₐ_{ᵢ}) contains all target words aligned to sₐ_{ᵢ} in the parallel corpus.

Because U(sₐ_{ᵢ}) may be quite large and contain many wrong translations caused by wrong alignments, “banana” may actually be included in U(“ [symbol] ”). To mitigate the effect of uncommon examples, we use a translation probability distribution (TPD) to sample noise t′₁ from U(sₐ_{ᵢ})\{tᵢ} as follows,

$$q ( {t}_{i}^{″} \vert {s}_{{a}_{i}} ) = \frac{align ( {s}_{{a}_{i}} , {t}_{i}^{′} )}{{\sum }_{{t}_{i}^{″} ∈ U ( {s}_{{a}_{i}} )} align ( {s}_{{a}_{i}} , {t}_{i}^{″} )}$$

where align(sₐ_{ᵢ}, t′ᵢ) is how many times t′₁ is aligned to sₐ_{ᵢ} in the parallel corpus.

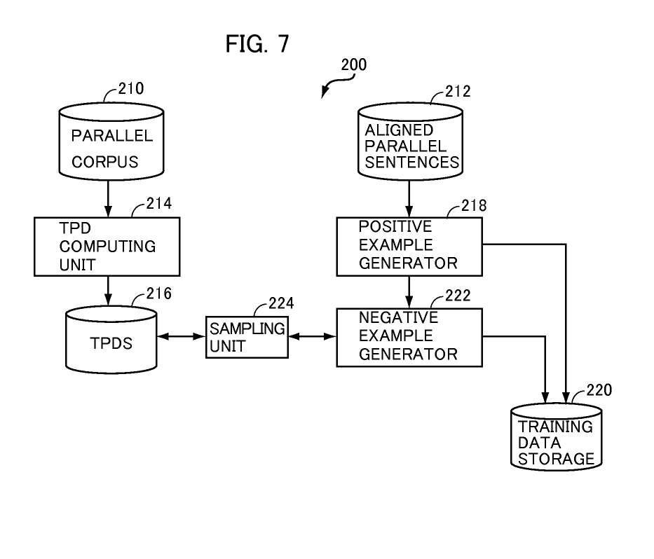

FIG. 7 shows a schematic structure of a training data generating system 200 for generating training data of neural network 80. Referring to FIG. 7, training data generating system 200 includes storage 210 for storing parallel corpus including a large number of aligned parallel sentences, storage 212 for storing parallel sentences with accurate alignment, a TPD computing unit 214 for computing TPDs for each of the target words in the parallel corpus stored in storage 210, storage 216 for storing the TPDs computed by TPD computing unit 214.

Training data generating system 200 further includes a positive example generator 218 connected to storage 212 for generating positive example for training neural network 80 from the parallel sentences stored in storage 212, a negative example generator 222 connected to positive example generator 218 for generating a negative example for each of the positive examples generated by positive example generator 218, a sampling unit 224 connected to negative example generator 222 and storage 216 responsive to a request from negative example generator 222 for sampling a noise word for generating a negative sample in accordance with the TPD stored in storage 216 corresponding to the current target word used for generating a positive example, and storage 220 for storing training data including the positive examples generated by positive example generator 218 and the negative examples generated by negative example generator 222.

Note that tᵢ could be unaligned, in which case we assume that it is aligned to a special null word. Noise for unaligned words is sampled according to the TPD of the null word.

If several target/source words are aligned to one source/target word, we choose to combine these target/source words as a new target/source word. The processing for multiple alignments helps sample more useful negative examples for TPD, and had little effect on the translation performance when UPD is used as the noise distribution for the NNJM and the BNNJM in our preliminary experiments.

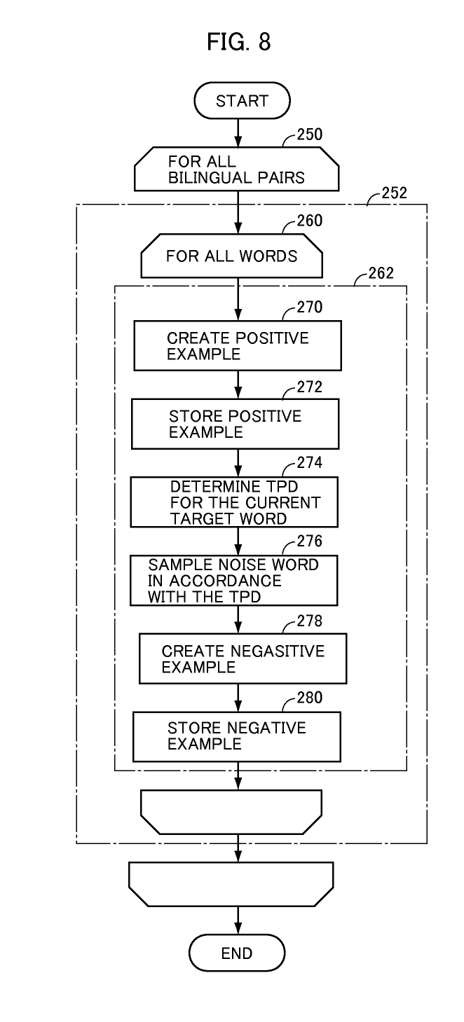

FIG. 8 shows an overall control structure of a computer program for generating a positive example and a negative example for training neural network 80 in accordance with the present embodiment.

Referring to FIG. 8, the program includes the step 250 of performing a routine 252 for all of the parallel sentences to be aligned.

Routine 252 includes the step 260 of performing a routine 262 for all words in the source sentence to be aligned. Routine 262 includes a step 270 of creating positive example using the target word of the accurate alignment by positive example generator 218 in FIG. 7, a step 272 of storing the positive example in storage 220, a step 274 of determining a TPD for the current target word, a step 276 of sampling a noise alignment word in accordance with the TPD determined in step 274, a step 278 of creating a negative example in negative example generator 222, and a step 280 of storing the negative example in storage 220.

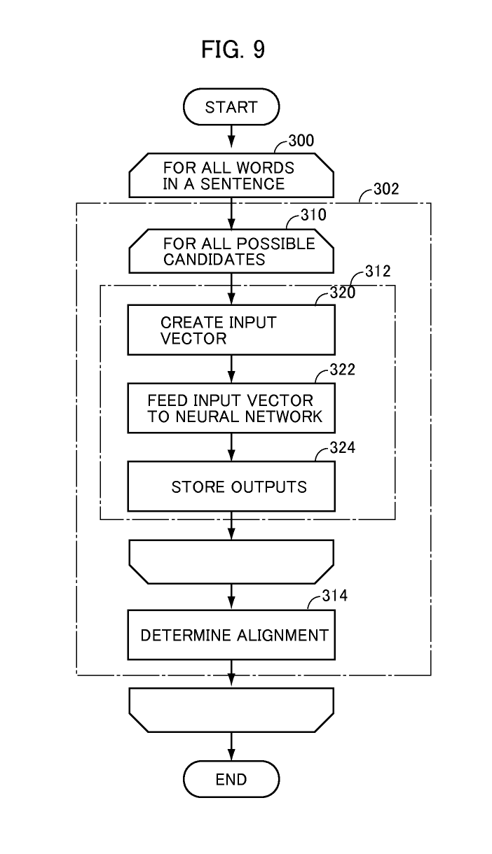

FIG. 9 shows an overall control structure of a computer program for aligning parallel sentences using neural network 80 in accordance with the present embodiment. When run on a computer, this program will cause the computer to function as a parallel sentence aligning system.

Referring to FIG. 9, the program includes the step 300 of performing a routine 302 for each of the words n a source sentence of a sentence pair to be aligned. Routine 302 includes the steps 310 of performing a routine 312 for each of the possible candidate for the current source word, and a step 314 for determining the alignment in accordance with the result of step 310.

Routine 312 includes a step 320 of creating an input vector from the source sentence and the target sentence to be aligned, a step 322 for feeding the input vector created in step 320 to neural network 80 shown in FIG. 2, and a step 324 for storing outputs of neural network 80 in storage, for instance a random access memory or a hard disk drive of a computer.

When step 310 ends, the storage of the parallel sentence aligning system will be retaining the data that shows the probabilities of each word of the source sentence being aligned to each word of the target sentence. By evaluating these probabilities, the alignment will be determined.

In the above-described embodiment, the output layer 94 includes two nodes 160 and 162 for outputting probabilities P(tᵢ is correct) and P(tᵢ is incorrect), respectively. The present invention, however, is not limited to such an embodiment. For instance, the output layer may include only one output nodes which will output either the probability P(tᵢ is correct), or the probability P(tᵢ is incorrect). In the alternative, the input vector may include a combination of two or more target words (tᵢ and tᵢ₊₁, for example). In this case, the output layer may include three or more output nodes for outputting the combination of probabilities P(tᵢ is correct), P(tᵢ is incorrect), P(tᵢ₊₁ is correct), P(tᵢ₊₁ is incorrect). In this case, however, the training data will be sparse and the training will be difficult and time consuming.

### Hardware Configuration

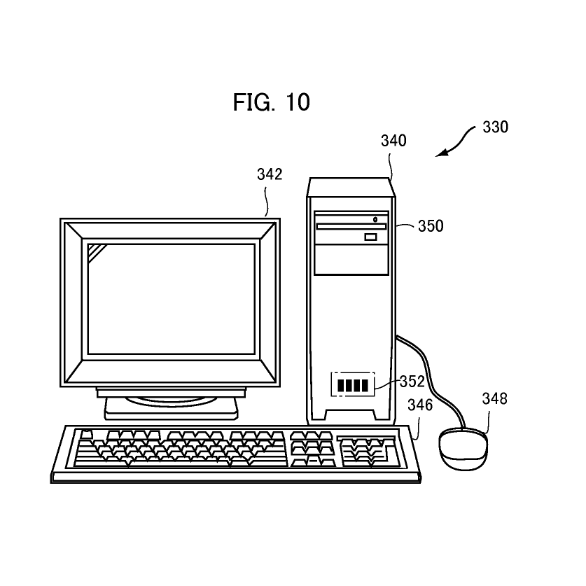

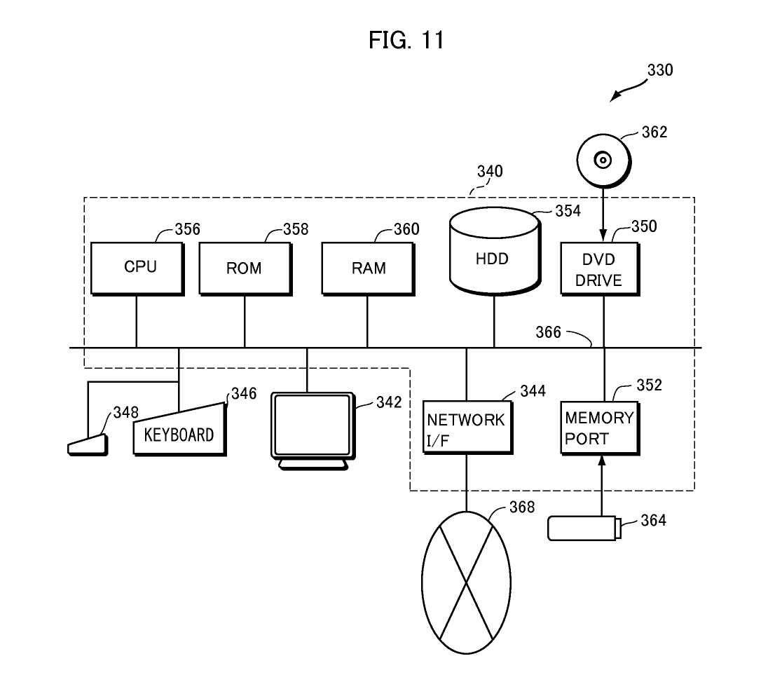

The system in accordance with the above-described embodiment can be realized by computer hardware and the above-described computer program executed on the computer hardware. FIG. 10 shows an appearance of such a computer system 330, and FIG. 11 shows an internal configuration of computer system 330.

Referring to FIG. 10, computer system 330 includes a computer 340 including a memory port 352 and a DVD (Digital Versatile Disc) drive 350, a keyboard 346, a mouse 348, and a monitor 342.

Referring to FIG. 11, in addition to memory port 352 and DVD drive 350, computer 340 includes: a CPU (Central Processing Unit) 356; a hard disk drive 354, a bus 366 connected to CPU 356, memory port 352 and DVD drive 350; a read only memory (ROM) 358 storing a boot-up program and the like; and a random access memory (RAM) 360, connected to bus 366, for storing program instructions, a system program, the parameters for the neural network, work data and the like. Computer system 330 further includes a network interface (I/F) 344 providing network connection to enable communication with other terminals over network 368. Network 368 may be the Internet.

The computer program causing computer system 330 to function as various functional units of the embodiment above is stored in a DVD 362 or a removable memory 364, which is loaded to DVD drive 350 or memory port 352, and transferred to hard disk drive 354. Alternatively, the program may be transmitted to computer 340 through a network 368, and stored in hard disk 354. At the time of execution, the program is loaded to RAM 360. Alternatively, the program may be directly loaded to RAM 360 from DVD 362, from removable memory 364, or through the network.

The program includes a sequence of instructions consisting of a plurality of instructions causing computer 340 to function as various functional units of the system in accordance with the embodiment above. Some of the basic functions necessary to carry out such operations may be provided by the operating system running on computer 340, by a third-party program, or various programming tool kits or program library installed in computer 340. Therefore, the program itself may not include all functions to realize the system and method of the present embodiment. The program may include only the instructions that call appropriate functions or appropriate program tools in the programming tool kits in a controlled manner to attain a desired result and thereby to realize the functions of the system described above. Naturally the program itself may provide all necessary functions.

In the embodiment shown in FIGS. 2 to 9, the training data, the parameters of each neural network and the like are stored in RAM 360 or hard disk 354. The parameters of sub-networks may also be stored in removable memory 364 such as a USB memory, or they may be transmitted to another computer through a communication medium such as a network.

The operation of computer system 330 executing the computer program is well known. Therefore, details thereof will not be repeated here.

### Experiments

In this section, we describe our experiments and give detailed analyses about translation results.

### Setting

We evaluated the effectiveness of the proposed approach for Chinese-to-English (CE), Japanese-to-English (JE) and French-to-English (FE) translation tasks. The datasets officially provided for the patent machine translation task at NTCIR-9 (Goto et al., 2011) were used for the CE and JE tasks. The development and test sets were both provided for the CE task while only the test set was provided for the JE task. Therefore, we used the sentences from the NTCIR-9 JE test set as the development set. Word segmentation was done by BaseSeg (Zhao et al., 2006) for Chinese and Mecab for Japanese. For the FE language pair, we used standard data for the WMT 2014 translation task. The detailed statistics for training, development and test sets are given in Table 1.

TABLE 1

| | |
|---|---|
| SOURCE | TARGET |

| | | | |
|---|---|---|---|
| CE | TRAINING | #Sents | 954K |

| | | |
|---|---|---|
| #Words | 37.2M | 40.4M |
| #Vocab | 288K | 504K |

| | | | |
|---|---|---|---|
| | DEV | #Sents | 2K |
| | TEST | #Sents | 9K |
| JE | TRAINING | #Sents | 3.14M |

| | | |
|---|---|---|
| #Words | 118M | 104M |
| #Vocab | 150K | 273K |

| | | | |
|---|---|---|---|
| | DEV | #Sents | 2K |
| | TEST | #Sents | 2K |
| FE | TRAINING | #Sents | 1.99M |

| | | |
|---|---|---|
| #Words | 60.4M | 54.4M |
| #Vocab | 137K | 114K |

| | | |
|---|---|---|
| DEV | #Sents | 3K |
| TEST | #Sents | 3K |

For each translation task, a recent version of Moses HPB decoder (Koehn et al., 2007) with the training scripts was used as the baseline (Base). We used the default parameters for Moses, and a 5-gram language model was trained on the target side of the training corpus using the IRSTLM Toolkit with improved Kneser-Ney smoothing. Feature weights were tuned by MERT (Och, 2003).

The word-aligned training set was used to learn the NNJM and the BNNJM. For both NNJM and BNNJM, we set m=7 and n=5. The NNJM was trained by NCE using UPD and TPD as noise distributions. The BNNJM was trained by standard MLE using UPD and TPD to generate negative examples.

The number of noise samples for NCE was set to be 100. For the BNNJM, we used only one negative example for each positive example in each training epoch, as the BNNJM needs to calculate the whole neural network for each noise sample and thus noise computation is more expensive. However, for different epochs, we re-sampled the negative example for each positive example, so the BNNJM can make use of different negative examples.

Both the NNJM and the BNNJM had one hidden layer, 100 hidden nodes, input embedding dimension 50, output embedding dimension 50. A small set of training data was used as validation data. The training process was stopped when validation likelihood stopped increasing.

### Results and Discussion

TABLE 2

| | | |
|---|---|---|
| CE | JE | FE |

| | | E | T | E | T | E | T |
|---|---|---|---|---|---|---|---|
| NNJM | UPD | 20 | 22 | 19 | 49 | 20 | 28 |
| | TPD | 4 | | 6 | | 4 | |
| BNNJM | UPD | 14 | 16 | 12 | 34 | 11 | 22 |
| | TPD | 11 | | 9 | | 9 | |

Table 2 shows how many epochs these two models needed and the training time for each epoch on a 10-core 3.47 GHz Xeon X5690 machine. In Table 2, E stands for epochs and T stands for time in minutes per epoch. The decoding time for the NNJM and the BNNJM were similar, since the NNJM does not need normalization and the BNNJM only needs to be normalized over two output neurons. Translation results are shown in Table 3.

TABLE 3

| | | CE | JE | FE |
|---|---|---|---|---|
| Base | | 32.95 | 30.13 | 24.56 |
| NNJM | UPD | 34.36+ | 31.30+ | 24.68 |
| | TPD | 34.60+ | 31.50+ | 24.80 |
| BNNJM | UPD | 32.89 | 30.04 | 24.50 |
| | TPD | 35.05+* | 31.42+ | 25.84+* |

From Table 2, we can see that using TPD instead of UPD as a noise distribution for the NNJM trained by NCE can speed up the training process significantly, with a small improvement in training performance. But for the BNNJM, using different noise distribution affects translation performance significantly. The BNNJM with UPD does not improve over the baseline system, likely due to the small number of noise samples used in training the BNNJM, while the BNNJM with TPD achieves good performance, even better than the NNJM with TPD on the Chinese-to-English and French-to-English translation tasks.

Table 3 shows translation results. The symbol + and * represent significant differences at the p<0.01 level against Base and NNJM+UPD, respectively. Significance tests were conducted using bootstrap re-sampling (Koehn, 2004).

From Table 3, the NNJM does not improve translation performance significantly on the FE task. Note that the baseline for FE task is lower than CE and JE tasks, so the translation learning task is harder for the FE task than JE and CE tasks. The validation perplexities of the NNJM with UPD for CE, JE and FE tasks are 4.03, 3.49 and 8.37. The NNJM learns the FE task clearly not as well as CE and JE tasks, which does not achieve significant translation improvement over baseline for the FE task. While the BNNJM improves translations significantly for the FE task, which demonstrates the BNNJM can learn the translation task well even if it is hard for the NNJM.

| | |
|---|---|
| Source | [symbol] (this) [symbol] (movement) [symbol] (continued) [symbol] (until) [symbol] (parasite) |
| | [symbol] (by) [symbol] (two) [symbol] (tongues) [symbol] 21 [symbol] (each other) [symbol] (contact) |
| | [symbol] (where) [symbol] [symbol] (point) [symbol] (touched) |
| Reference | this movement is continued until the parasite is |
| | touched by the point where the two tongues 21 contact |
| | each other. |
| T₁(NNJM TPD) | the mobile continues to the parasite from the two |
| | tongue 21 contacts the points of contact with |
| | each other. |
| T₂(BNNJM TPD) | this movement is continued until the parasite |
| | by two tongue 21 contact points of contact with |
| | each other. |

### Table 4: Translation Examples

Table 4 gives Chinese-to-English translation examples to demonstrate how the BNNJM helps to improve translations over the NNJM. In this case, the BNNJM clearly helps to translate the phrase “ [symbol] [symbol] ” better. Table 5 gives translation scores for these two translations calculated by the NNJM and the BNNJM. Context words are used for predictions but not shown in the table.

TABLE 5

| | NNJM | BNNJM |
|---|---|---|
| [symbol] ->the | 1.681 | −0.126 |
| [symbol] ->mobile | −4.506 | −3.758 |
| [symbol] ->continues | −1.550 | −0.130 |
| [symbol] ->to | 2.510 | −0.220 |
| SUM | −1.865 | −4.236 |
| [symbol] ->this | −2.414 | −0.649 |
| [symbol] ->movement | −1.527 | −0.200 |
| null->is | 0.006 | −0.55 |
| [symbol] ->continued | −0.292 | −0.249 |
| [symbol] ->until | −6.846 | −0.186 |
| SUM | −11.075 | −1.341 |

As can be seen, the BNNJM prefers T₂ while the NNJM prefers T₁. Among these predictions, the NNJM and the BNNJM predict the translation for “ [symbol] ” most differently. The NNJM clearly predicts that in this case “ [symbol] ” should be translated into “to” more than “until”, likely because this example rarely occurs in the training corpus. However, the BNNJM prefers “until” more than “to”, which demonstrates the BNNJM's robustness to less frequent examples.

### Analysis for JE Translation Results

Finally, we examine the translation results to explore why the BNNJM did not outperform the NNJM for the JE translation task, as it did for the other translation tasks. We found that using the BNNJM instead of the NNJM on the JE task did improve translation quality significantly for content words, but not for function words.

First, we describe how we estimate translation quality for content words. Suppose we have a test set S, a reference set R and a translation set T with I sentences,

Sᵢ(1≦i≦I), Rᵢ(1≦i≦I), Tᵢ(1≦i≦I)

Tᵢ contains J individual words,

Wᵢⱼ ∈ Words(Tᵢ)
T_{O}(Wᵢⱼ is how many times Wᵢⱼ occurs in Tᵢ and
R_{O}(Wᵢⱼ) is how many times Wᵢⱼ occurs in Rᵢ.

The general 1-gram translation accuracy (Papineni et al., 2002) is calculated as,

$${P}_{g} = \frac{{\sum }_{i = 1}^{I} {\sum }_{j = 1}^{J} min ( {T}_{o} ( {W}_{i , j} ) , {R}_{o} ( {W}_{ij} ) )}{{\sum }_{i = 1}^{I} {\sum }_{j = 1}^{J} {T}_{o} ( {W}_{i , j} )}$$

This general 1-gram translation accuracy does not distinguish content words and function words.

We present a modified 1-gram translation accuracy that weights content words more heavily,

$${P}_{c} = \frac{{\sum }_{i = 1}^{I} {\sum }_{j = 1}^{J} min ( {T}_{o} ( {W}_{i , j} ) , {R}_{o} ( {W}_{ij} ) ) \cdot \frac{1}{Occur ( {W}_{ij} )}}{{\sum }_{i = 1}^{I} {\sum }_{j = 1}^{J} {T}_{o} ( {W}_{i , j} )}$$

where Occur (Wᵢⱼ) is how many times Wᵢⱼ occurs in the whole reference set. Occur (Wᵢⱼ) for function words will be much larger than content words. Note P_{c} is not exactly a translation accuracy for content words, but it can approximately reflect content word translation accuracy, since correct function word translations contribute less to P_{c}.

TABLE 6
1-gram precisions (%) and improvements.

| | CE | JE | FE |
|---|---|---|---|
| NNJM TPD P_{g} | 70.3 | 68.2 | 61.2 |
| BNNJM TpD P_{g} | 70.9 | 68.4 | 61.7 |
| Improvements | 0.0085 | 0.0029 | 0.0081 |
| NNJM TPD P_{c} | 5.79 | 4.15 | 6.70 |
| BNNJM TPD P_{c} | 5.97 | 4.30 | 6.86 |
| Improvements | 0.031 | 0.036 | 0.024 |

Table 6 shows P_{g} and P_{c} for different translation tasks. It can be seen that the BNNJM improves content word translation quality similarly for all translation tasks, but improves general translation quality less for the JE task than the other translation tasks. We analyze that the reason why the BNNJM is less useful for function word translations on JE task should be the fact that the JE parallel corpus has less accurate function word alignments than other language pairs, as the grammatical features of Japanese and English are quite different. Wrong function word alignments will make noise sampling less effective and therefore lower the BNNJM performance for function word translations. Although wrong word alignments will also make noise sampling less effective for the NNJM, the BNNJM only uses one noise sample for each positive example, so wrong words alignments affect the BNNJM more than the NNJM.

### Conclusion

The present embodiment proposes an alternative to the NNJM, the BNNJM, which learns a binary classifier that takes both the context and target words as input and combines all useful information in the hidden layers. The noise computation is more expensive for the BNNJM than the NNJM trained by NCE, but a noise sampling method based on translation probabilities allows us to train the BNNJM efficiently. With the improved noise sampling method, the BNNJM can achieve comparable performance with the NNJM and even improve the translation results over the NNJM on Chinese-to-English and French-to-English translations.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### REFERENCES

Jacob Andreas and Dan Klein. 2015. When and why are log-linear models self-normalizing? In Proceedings of the 2015 Conference of the North American Chapter of the Association for Computational Linguistics: Human Language Technologies, pages 244-249.

Michael Auli, Michel Galley, Chris Quirk, and Geoffrey Zweig. 2013. Joint language and translation modeling with recurrent neural networks. In Proceedings of the 2013 Conference on Empirical Methods in Natural Language Processing, pages 1044-1054.

Jacob Devlin, Rabih Zbib, Zhongqiang Huang, Thomas Lamar, Richard Schwartz, and John Makhoul. 2014. Fast and robust neural network joint models for statistical machine translation. In Proceedings of the 52nd Annual Meeting of the Association for Computational Linguistics (Volume 1: Long Papers), pages 1370-1380.

Isao Goto, Bin Lu, Ka Po Chow, Eiichiro Sumita, and Benjamin K Tsou. 2011. Overview of the patent machine translation task at the NTCIR-9 workshop. In Proceedings of The 9th NII Test Collection for IR Systems Workshop Meeting, pages 559-578.

Yuening Hu, Michael Auli, Qin Gao, and Jianfeng Gao. 2014. Minimum translation modeling with recurrent neural networks. In Proceedings of the 14th Conference of the European Chapter of the Association for Computational Linguistics, pages 20-29.

Philipp Koehn, Hieu Hoang, Alexandra Birch, Chris Callison-Burch, Marcello Federico, Nicola Bertoldi, Brooke Cowan, Wade Shen, Christine Moran, Richard Zens, Chris Dyer, Ondrej Bojar, Alexandra Constantin, and Evan Herbst. 2007. Moses: Open source toolkit for statistical machine translation. In Proceedings of the 45th Annual Meeting of the Association for Computational Linguistics Companion Volume Proceedings of the Demo and Poster Sessions, pages 177-180.

Philipp Koehn. 2004. Statistical significance tests for machine translation evaluation. In Proceedings of EMNLP 2004, pages 388-395.

Arne Mauser, Sa\check{s}a Hasan, and Hermann Ney. 2009. Extending statistical machine translation with discriminative and trigger-based lexicon models. In Proceedings of the 2009 Conference on Empirical Methods in Natural Language Processing, pages 210-218.

Franz Josef Och. 2003. Minimum error rate training in statistical machine translation. In Proceedings of the 41st Annual Meeting of the Association for Computational Linguistics, pages 160-167.

Kishore Papineni, Salim Roukos, Todd Ward, and WeiJing Zhu. 2002. Bleu: a method for automatic evaluation of machine translation. In Proceedings of 40th Annual Meeting of the Association for Computational Linguistics, pages 311-318.

Holger Schwenk. 2012. Continuous space translation models for phrase-based statistical machine translation. In Proceedings of COLING 2012: Posters, pages 1071-1080.

Martin Sundermeyer, Tamer Alkhouli, Joern Wuebker, and Hermann Ney. 2014. Translation modeling with bidirectional recurrent neural networks. In Proceedings of the 2014 Conference on Empirical Methods in Natural Language Processing (EMNLP), pages 14-25.

Ashish Vaswani, Yinggong Zhao, Victoria Fossum, and David Chiang. 2013. Decoding with largescale neural language models improves translation. In Proceedings of the 2013 Conference on Empirical Methods in Natural Language Processing, pages 1387-1392.

Puyang Xu, Asela Gunawardana, and Sanjeev Khudanpur. 2011. Efficient subsampling for training complex language models. In Proceedings of the 2011 Conference on Empirical Methods in Natural Language Processing, pages 1128-1136.

Hai Zhao, Chang-Ning Huang, and Mu Li. 2006. An improved Chinese word segmentation system with conditional random field. In Proceedings of the Fifth SIGHAN Workshop on Chinese Language Processing, pages 162-165.

What is claimed is:

1. A neural network system for aligning a source word in a source sentence to a word or words in a target sentence parallel to the source sentence, including:
an input layer connected to receive an input vector, the input vector including an m-word source context (m being an integer larger than two) of the source word, n−1 target history words (n being an integer larger than two), and a current target word in the target sentence;
a hidden layer connected to receive the outputs of the input layer for transforming the outputs of the input layer using a pre-defined function and outputting the transformed outputs; and
an output layer connected to receive outputs of the hidden layer for calculating and outputting an indicator with regard to the current target word being a translation of the source word.

2. The neural network system in accordance with claim 1 where the output layer includes a first output node connected to receive outputs of the hidden layer for calculating and outputting a first indicator of the current target word being the translation of the source word.

3. The neural network system in accordance with claim 2 wherein the first indicator indicates a probability of the current target word being the translation of the source word.

4. The neural network system in accordance with claim 2, wherein the output layer further includes a second output node connected to receive outputs of the hidden layer for calculating and outputting a second indicator of the current target word not being the translation of the source word.

5. The neural network system in accordance with claim 4, wherein the second indicator indicates a probability of the current target word not being the translation of the source word.

6. The neural network system in accordance with claim 1, wherein the number m is an odd integer larger than two.

7. The neural network system in accordance with claim 6, wherein the m-word source context includes (m−1)/2 words immediately before the source word in the source sentence, and (m−1)/2 words immediately after the source word in the source sentence, and the source word.

8. A computer-implemented method of generating training data for training the neural network system in accordance with any of claims 1 to 7, the computer including a processor, storage, and a communication unit capable of communicating external device, the method including the steps of:
causing the communication unit to connect to a first storing device and a second storing device, the first storing device storing a translation probability distribution (TPD) of each of target language words in a corpus, and the second storing device storing a set of parallel sentence pairs of a source language and a target language,
causing the processor to select one of the sentence pairs stored in the second storing device,
causing the processor to select each of words in the source language sentence in the selected sentence pairs,
causing the processor to generate a positive example using the selected source word, m-word source context, n−1 target word history, and a target word aligned with the selected source word in the sentence pairs, and a positive flag,
causing the processor to select a TPD for the target word aligned with the selected source word,
causing the processor to sample a noise word in the target language in accordance with the selected TPD, and
causing the processor to generate a negative example using the selected source word, m-word source context, n−1 target word history, a target word sampled in accordance with the selected TPD, and a negative flag, and
causing the processor to store the positive example and the negative example in the storage.

9. A computer program embodied on a computer-readable medium for causing a computer to generate training data for training a neural network, the computer including a processor, storage, and a communication unit capable of communicating with external devices, the computer program including:
a computer code segment for causing the communication unit to connect to a first storing device and a second storing device, the first storing device storing translation probability distribution (TPD) of each of target language words in a corpus, and the second storing device storing a set of parallel sentence pairs of a source language and a target language,
a computer code segment for causing the processor to select one of the sentence pairs stored in the second strong device,
a computer code segment for causing the processor to select each of words in the source language sentence in the selected sentence pairs,
a computer code segment for causing the processor to generate a positive example using the selected source word, m-word source context, n−1 target word history, a target word aligned with the selected source word in the sentence pairs, and a positive flag,
a computer code segment for causing the processor to select a TPD for the target word aligned with the selected source word,
a computer code segment for causing the processor to sample a noise word in the target language in accordance with the selected TPD, and
a computer code segment for generating a negative example using the selected source word, m-word source context, n−1 target word history, and a target word sampled in accordance with the selected TPD, and a negative flag, and
a computer code segment for causing the processor to store the positive example and the negative example in the storage.
